(19) United States
(12) Patent Application Publication
(10) Pub. No.: US 2025/0077589 A1
(43) Pub. Date: Mar. 6, 2025

(54) DOCUMENT MANAGEMENT METHOD AND APPARATUS THEREFOR

(71) Applicant: Do Cheon JEONG, Seoul (KR)

(72) Inventor: Do Cheon JEONG, Seoul (KR)

(21) Appl. No.: 18/681,023

(22) PCT Filed: Aug. 18, 2022
(86) PCT No.: PCT/KR2022/012336

§ 371 Date: Feb. 2, 2024

(30) Foreign Application Priority Data
Aug. 18, 2021 (KR) 10-2021-0108961
Aug. 8, 2022 (KR) 10-2022-0098877

(51) Int. Cl. G06F 16/93; H04N 1/00; H04N 1/21

(52) U.S. Cl. CPC G06F 16/93; H04N 1/00251; H04N 1/00344; H04N 1/00408; H04N 1/2166

(57) ABSTRACT

A document management method and an apparatus therefor are disclosed. A user terminal obtains document content on a document to be stored in a document storage box, registers the document content in a document management apparatus, receives unique information from the document management apparatus, and inputs the unique information into a wireless tag located at one side of the document storage box in which the document is stored. The document management apparatus maps the document content to unique information assigned to the wireless tag of the document storage box and stores and manages the same. In addition, when logging in with a user account licensed by the document management apparatus, user interface including a menu for editing or registering document content is provided to the user terminal, and when logging in with an unlicensed user account, user interface excluding the menu so that editing or registration of document content is not possible is provided to the user terminal.

### TECHNICAL FIELD

The present invention relates to a document management method and an apparatus therefor. More specifically, the present invention relates to a method for efficiently managing documents existing as physical objects by placing them in a document storage box, and an apparatus therefor.

### BACKGROUND ART

In everyday life, there are many types of documents that are produced, distributed, and stored as physical objects (e.g., paper) rather than electronic documents. In order to manage these documents in the form of physical objects, document binders or binding tools are used to bundle the documents together, and then labels are created and attached to the bundled documents. When managing a large amount of documents in a single bundle using binders or binding tools, the label information attached to the binder is not enough to manage the content of the documents in each bundle.

In addition, electronic documents may be stored and managed in a database. Since electronic documents can be easily edited or deleted, it is necessary to control access to electronic documents for security purposes. For example, it may be possible to solve security issues by providing access to electronic documents to only a few user accounts. When the user with access to electronic documents is changed due to retirement, leave of absence, or job change, there may be an inconvenience such that the existing user account needs to be deleted and a new user account needs to be registered. In addition, when an existing user account with access to electronic documents is deleted, there may be an inconvenience such that a separate account needs to be created for the user and access to the account needs be granted in order to perform tasks other than document management task.

### DETAILED DESCRIPTION

### Technical Task

It is an object of the present invention to provide a document management method for efficiently managing information on documents stored in a document storage box through a server, and an apparatus therefor.

It is another object of the present invention to provide a document management method allowing a licensed user to edit, delete or register information on documents managed by a server, and an apparatus therefor.

### Means for Solving Task

In order to achieve the technical tasks, the document management method according to an embodiment of the present invention performed by a user terminal, comprises: obtaining document content on a document to be stored in a document storage box; registering the document content in a document management apparatus; receiving unique information from the document management apparatus; and inputting the unique information into a wireless tag located at one side of the document storage box in which the document is stored.

In order to achieve the technical task, the document management method according to another embodiment of the present invention performed by a document management apparatus, comprises: receiving document content on a document stored in a document storage box; and mapping the document content to unique information assigned to a wireless tag located at one side of the document storage box, and storing the same.

In order to achieve the technical task, the document management system according to an embodiment of the present invention comprises: at least one document storage box for storing documents; and a wireless tag attached to one side of each document storage box, wherein the wireless tag comprises unique information identifying the document content on the document stored in the document storage box.

### Effect of Invention

According to an embodiment of the present invention, information on documents stored in a document storage box may be easily managed using a wireless tag (e.g., near field communication (NFC) tag) attached to the document storage box. According to another embodiment, document content such as photograph of a document stored in the document storage box may be registered in a server and checked when necessary. The document management method using a wireless tag may also be applied to logistics boxes, medicine packages, food packages, etc. According to another embodiment, the right to edit, delete, or add document content stored in a server may be managed through licenses. In addition, licenses may be transferred among user accounts to easily change who is in control of document content management.

### BRIEF DESCRIPTION OF DRAWINGS

FIG. 1 is a drawing illustrating an example of an overall system structure for document management according to an embodiment of the present invention;

FIG. 2 is a drawing illustrating an example of a document storage box according to an embodiment of the present invention;

FIG. 3 is a flow chart illustrating an example of a document management method according to an embodiment of the present invention;

FIG. 4 is a drawing illustrating an example of information on a document stored in a document management apparatus according to an embodiment of the present invention;

FIGS. 5 to 8 are drawings illustrating examples of user interface of a user terminal for document management according to an embodiment of the present invention;

FIGS. 9 to 13 are drawings illustrating examples of a document storage box according to an embodiment of the present invention;

FIG. 14 is a drawing illustrating an example of an overall system structure for licensed document management according to an embodiment of the present invention;

FIG. 15 is a drawing illustrating an example of a licensed management method according to an embodiment of the present invention;

FIG. 16 is a drawing illustrating an example of a method of moving document content according to an embodiment of the present invention;

FIG. 17 is a flow chart illustrating an example of a licensed document management method according to an embodiment of the present invention;

FIG. 18 is a drawing illustrating an example of a method of checking document information when logging in with a licensed user account; and

FIG. 19 is a drawing illustrating the configuration of an example of a document management apparatus according to an embodiment of the present invention.

### BEST MODE FOR CARRYING OUT THE INVENTION

Hereinafter, a document management method and an apparatus therefor according to an embodiment of the present invention will be described in detail with reference to the accompanying drawings.

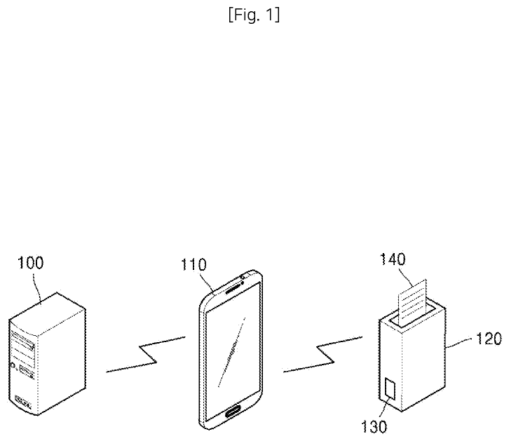

FIG. 1 is a drawing illustrating an example of an overall system structure for document management according to an embodiment of the present invention.

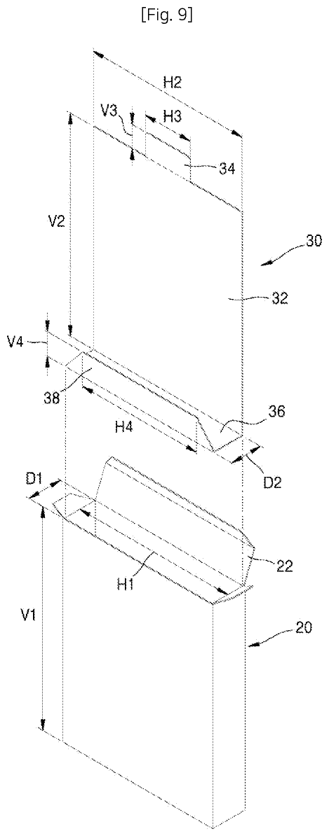

Referring to FIG. 1, a document storage box 120 comprises an interior space of a certain size for storing documents 140 existing as physical objects such as paper. The size of the document storage box 120 may vary according to embodiments, for example, it may be in the form of a rectangular box capable of storing tens to hundreds of A4-sized documents. Alternatively, the document storage box 120 may be of various shapes according to embodiments, such as a drawer-type storage box. In another embodiment, the document storage box 120 may be a tray structure to facilitate the storing and viewing of documents whose examples are illustrated in. FIGS. 9 to 13. Hereinafter, for the sake of convenience in explanation, it is assumed that the document storage box 120 is in the form of a rectangular box.

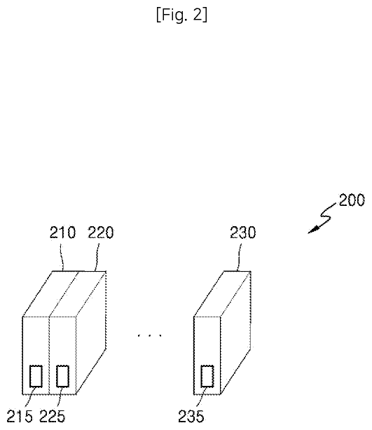

At one side of the document storage box 120, there is a wireless tag 130. The wireless tag 130 may be implemented as various types of tags capable of transmitting and receiving data via wireless communication. For example, NFC tag, radio frequency identification (RFID) tag are examples of wireless tags, and the present embodiment is not limited to any particular type. However, hereinafter, for the sake of convenience in explanation, an NFC tag will be described as an example of a wireless tag 130. The wireless tag 130 stores unique information for managing documents stored in the document storage box 120. A method for storing unique information in the wireless tag 130 will be described in more detail referring to FIG. 2 in the following.

The wireless tag 130 may be in the form of a sticker. In this case, the document storage box 120 and the wireless tag 130 exist separately, and the wireless tag 130 may be attached to the document storage box 120 when a user wants to use the document storage box 120 to store documents. In another embodiment, the wireless tag 130 may be pre-attached to the document storage box 120.

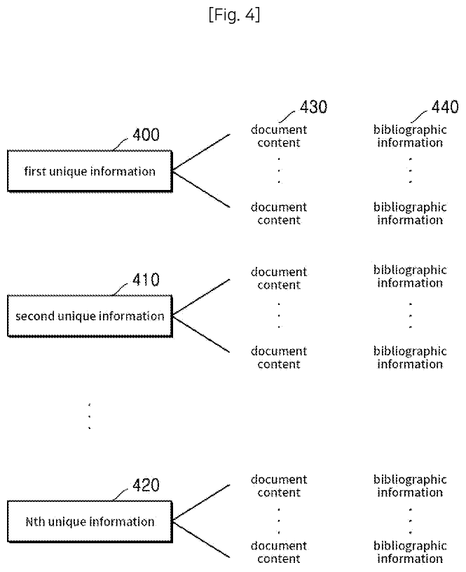

The document management apparatus 100 stores and manages information on the documents 140 stored in the document storage box 120. An example of information on the documents stored in the document management apparatus 100 is illustrated in FIG. 4. The document management apparatus 100 may be implemented as one or more physical servers or may be implemented as a cloud system. The document management apparatus 100 is not limited to the term itself, but can be any computing device that includes data storage and communication functions, and thus can be implemented as a general computer.

A user terminal 110 stores information on the document such as photograph of a document stored in the document storage box 120 in the document management apparatus 100, receives unique information for document management from the document management apparatus 100 and provides the same to the wireless tag 130. The user terminal 110 may have an application for document management method of the present embodiment. A method for a user to manage documents 140 stored in the document storage box 120 via a user terminal 110 will be described in more detail referring to FIG. 2 in the following. The user terminal 110 may be a variety of devices such as smartphones, tablet PCs, conventional computers. Hereinafter, for the sake of convenience in explanation, it is assumed that the user terminal 110 is a smartphone.

FIG. 2 is a drawing illustrating an example of a document storage box according to an embodiment of the present invention.

Referring to FIG. 2, the document management apparatus 200 comprises at least one document storage box 210, 220, 230, and at least one wireless tag 215, 225, 235. Each wireless tag 215, 225, 235 stores unique information for document management. As will be discussed later, a user may tag a wireless tag 215, 225, 235 located at one side of a document storage box 210, 220, 230 with a user terminal 110 and easily check information on documents stored in the corresponding document storage box 210, 220, 230.

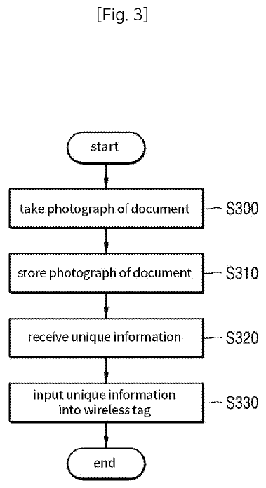

FIG. 3 is a flow chart illustrating an example of a document management method according to an embodiment of the present invention.

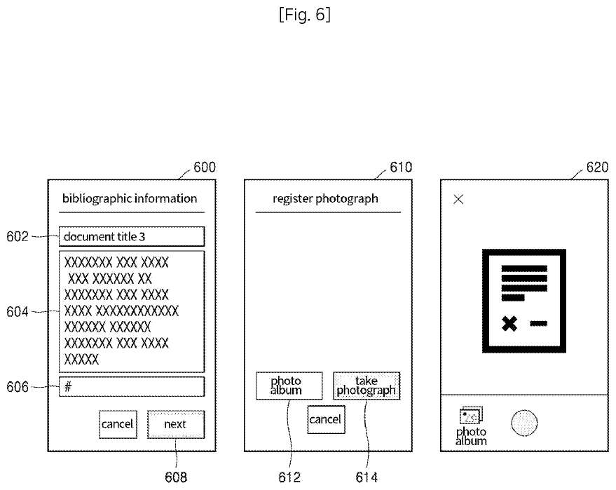

Referring to FIGS. 1 and 3 together, a user terminal 110 takes a photograph of a document 140 to be stored in the document storage box 120 (S300). For example, when storing a document consisting of 10 sheets in a first document storage box 210, a user may use the camera of a user terminal 110 to take photographs of the 10 sheets of documents. An example of the user interface of the user terminal 110 for taking photographs of the documents is illustrated in FIG. 6. The present embodiment presents photographs of the documents taken with a camera as an example of document content, but this is only an example, and the document content may be in various forms (e.g., scanned image, etc.) that include the content of a document. However, hereinafter, for the sake of convenience in explanation, it is assumed that the document content includes a photograph of the document. A separate login process may be included before the step of taking photographs when the document storage box is shared by multiple users. Of course, the login process may be omitted according to embodiments. The login process will be described again in FIG. 6.

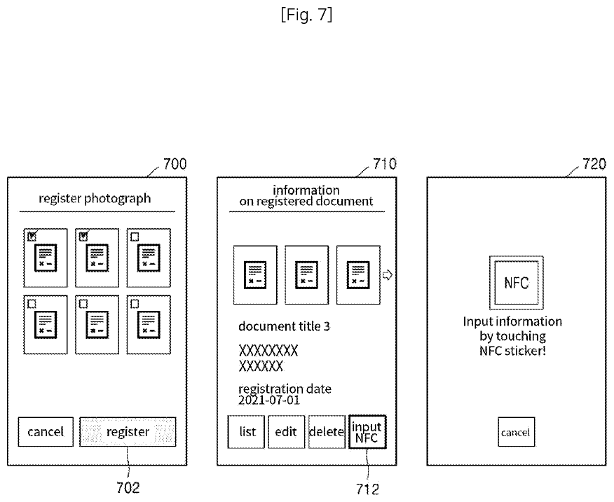

The user terminal 110 registers a document content such as a photograph of a document obtained by taking a photograph of the document 140 in a document management apparatus 100 (S310). In an embodiment, the user terminal 110 may receive bibliographic information on the document 140, and then transmit the document content such as photograph of the document together with the bibliographic information to the document management apparatus 100 for storage. Bibliographic information on the document 140 may include information such as document title, summary, keyword, registration date, registrant, audio recording file, music, sound source, link, etc. The type of information included in the bibliographic information of a document may vary according to embodiments. An example of a user interface for receiving bibliographic information on the document from a user is illustrated in FIG. 6. An example of a user interface for registering photograph of the document in a document management apparatus 100 is illustrated in FIG. 7.

The user terminal 110 receives unique information from the document management apparatus 100 after registering the document content (S320). From the perspective of the document management apparatus 100, upon receiving document content such as photograph of document from the user terminal 110, the document management apparatus 100 generates unique information and transmits the same to the user terminal 110, and then maps the generated unique information and document content to store and manage the same in a database.

The user terminal 110 inputs the unique information received from the document management apparatus 100 into a wireless tag 130 (S330). For example, when the wireless tag 130 is an NFC tag, the user terminal 110 transmits the unique information to the NFC tag via near field communication (NFC), and the NFC tag stores the unique information therein. When the wireless tag 130 exists separately, not integrally with the document storage box 120, a user may attach the wireless tag 130 input with the unique information to one side of the document storage box 120.

In an embodiment, the document storage box 120 may be implemented to be reusable. For example, new documents may be stored in an existing document storage box 120 after discarding all documents stored in the existing document storage box 120. In this case, unique information newly received from the document management apparatus 100 may be input to the wireless tag 130 attached to the existing document storage box 120 by the method described in the present embodiment. In another embodiment, the unique information of the wireless tag 130 attached to the existing document storage box 120 may be used as it is for reuse. In this case, upon registering a photograph of a new document in the document management apparatus 100, the user terminal 110 recognizes the unique information of the wireless tag 130 attached to the document storage box 120 through tagging, and transmits a request for reuse together with the unique information to the document management apparatus. The document management apparatus 100 may delete information on the previously stored document through mapping to the unique information received from the user terminal 110, and store information (document content, etc.) on the document such as photograph of the document currently newly received from the user terminal 110 through mapping to the existing unique information.

New documents may be added to the document storage box 120, or some of the documents stored in the existing document storage box may be discarded. In this case, the information on the documents stored in the document management apparatus 100 may be updated as new documents are added or discarded.

In an embodiment, when adding a new document to an existing document storage box 120, the user terminal 110 may take a photograph of the additional document, and transmit a document addition request including a photograph of the document to the document management apparatus 100 together with unique information of the wireless tag 130 attached to the existing document storage box 120. The document management apparatus 100 may map the additional document photograph to the unique information received from the user terminal 110 and store the same.

In another embodiment, when discarding the document from an existing document storage box 120, the user terminal 110 may transmit information on the discarded document (e.g., file name or identifier of the document photograph) to the document management apparatus 100 together with unique information of the wireless tag 130 of the document storage box 120. For example, the user terminal 110 may receive from the document management apparatus 100 a list of document information for each document storage box stored in the document management apparatus 100 and display the same, allowing a user to select a document to be discarded, or the user terminal 110 may transmit to the document management apparatus 100 unique information obtained by tagging the wireless tag of the document storage box from which the document is being discarded, and display a list of document information mapped to the corresponding unique information to the user to select the discarded document.

FIG. 4 is a drawing illustrating an example of information on a document stored in a document management apparatus according to an embodiment of the present invention.

Referring to FIG. 4, the document management apparatus 110 stores and manages document content 430 such as document photographs by mapping them to unique information 400, 410, 420 generated for each document storage box. When the number of document storage boxes in FIG. 2 is N, the document management apparatus 100 generates N unique information 400, 410, 420 for each document storage box.

For example, referring to FIG. 2, when the document management apparatus 100 receives document content 430 and bibliographic information 440 of a document stored in a first document storage box 210 from the user terminal 110, they are mapped to first unique information 400 generated for the first document storage box 210 to store the at least one document content 430 and bibliographic information 440 received from the user terminal 110. In the same manner, upon receiving document content and bibliographic information of the document stored in a second or Nth document storage box 220, 230, they are mapped to the second or Nth unique information 410, 420 to store the respective document content and bibliographic information.

The document storage box 120 may store one type of document or multiple documents of different types. For example, a single report consisting of a plurality of pages may be stored in the document storage box 120, or multiple reports may be stored together in the same document storage box 120. When storing only one type of document in the document storage box 120, a single bibliographic information 440 may be stored mapped to the unique information 400. However, when a plurality of different documents are stored, bibliographic information for each document may be stored. For example, when a first document and a second document, which are different types of documents, are stored in a first document storage box 210, the document management apparatus 100 may register the respective bibliographic information for the document content of the first document and the document content of the second document received from the user terminal 110, and then map them to the first unique information 400 for storage management. The first document or second document may comprise at least one document.

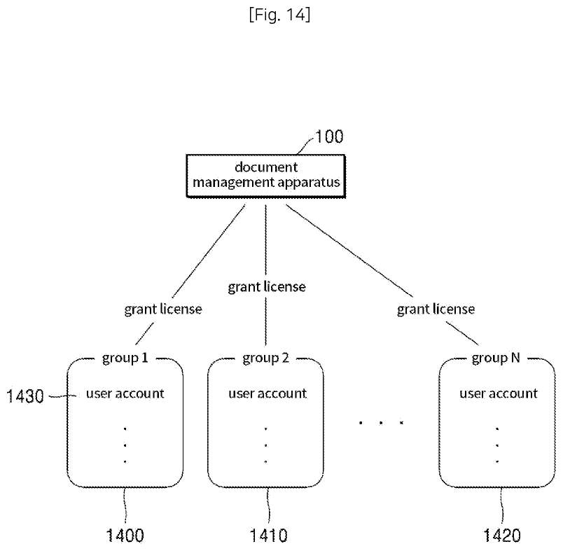

When a user performs a login process upon accessing the document management apparatus 100 for document storage management, the document management apparatus 100 may store user identification information (or user account information) together in order to distinguish information on the documents registered by each user (e.g., document content, bibliographic information, etc.). For example, when a first user stores a first document in a first document storage box 210 and a second user stores a second document in the same first document storage box 210, the document management apparatus 100 may additionally map and store identification information of the first user (or user account information of the first user) to the information on the first document stored by mapping to the first unique information 400 generated for the first document storage box 210, and additionally map and store identification information of the second user (or user account information of the second user) to the information on the second document. Based on the above, the document management apparatus 100 may select information on the document registered by each user and provide the same to the user terminal 110. In another embodiment, a license to manage document content may be granted to a user account. The document management method using a license will be described again in FIG. 14.

In another embodiment, the document management apparatus 100 may store identification information of the document storage box together with unique information. For example, when a first document storage box 210 is labeled with identification information of number “1,” the document management apparatus 100 may store and manage identification information of the first document storage box 210 labeled “1” by mapping it to the first unique information 400 granted to the wireless tag 130 attached to the first document storage box 210. Accordingly, when a user retrieves information on a document from the document management apparatus 100, the user may check in which document storage box the document retrieved is stored by using the identification information on the document storage box provided by the document management apparatus 100.

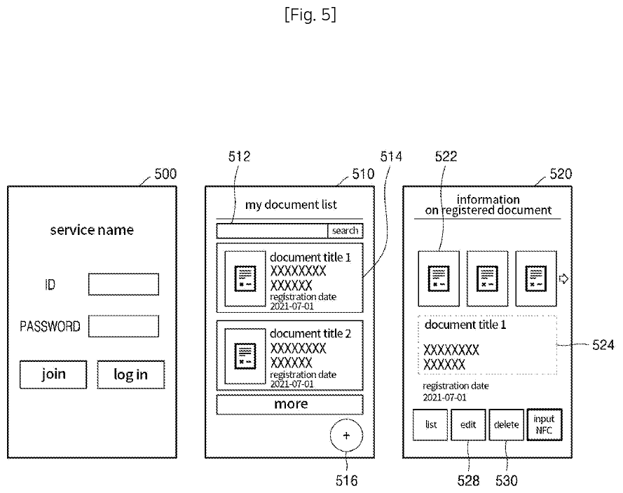

FIGS. 5 to 8 are drawings illustrating examples of user interface of a user terminal for document management according to an embodiment of the present invention. FIGS. 5 to 8 are merely examples to better understand the present invention, and the user interface may vary according to embodiments.

First, referring to FIG. 5, an example of a user interface for document information retrieval is illustrated. When a user runs an application for this embodiment, a login screen 500 appears on the screen of the user terminal. When the user is authenticated through the login screen 500, the document management apparatus 100 provides a list of documents to the user terminal 110 through a document list screen 510. In an embodiment, the document management apparatus 100 may provide a list of only the documents registered by the logged-in user, or may provide a list of all documents registered in the document management apparatus 100. The document list screen 510 may display thumbnails of document photographs and/or document bibliographic information 514 (e.g., document title or summary, etc.) in a list.

In another embodiment, the document list screen 510 may comprise a document search bar 512. For example, when a user enters a search term into the document search bar 512, the user terminal 110 may search for a document that matches the entered search term based on the document titles or keywords in the document list and provide the same.

When the user selects (i.e., clicks) a specific document on the document list screen 510, the user terminal 110 displays the selected document information on a screen 520. The document information screen 520 may display a thumbnail 522 and/or bibliographic information 524 of the document photograph. For example, when the document consists of a plurality of pages, the user terminal 110 may display a plurality of the document photographs of the selected document in various manners such as thumbnails 522, etc. When a user selects one of the document photograph thumbnails 522, the user terminal displays the selected document photograph to allow the user to check the content of the document.

In another embodiment, the document list screen 510 or the document information screen 520 may display identification information of the document storage box in which the document is stored. For example, the plurality of document storage boxes 210, 220, 230 in FIG. 2 have various identification information such as numbers or letters for distinguishing each document storage box displayed at one outer side of the document storage box, and such identification information may be registered in the document management apparatus 100 together with bibliographic information at the time of registering document photograph. The user may use identification information of the document storage box displayed on the document information screen to check the document storage box in which the document is stored.

The user may edit or delete information on the document stored in the document management apparatus through the document information screen. For example, when the user clicks the “edit” button 528, the user terminal 110 provides a bibliographic information registration screen for the document, allowing the user to edit bibliographic information. The user terminal 110 transmits the edited bibliographic information to the document management apparatus 100, and the document management apparatus 100 updates information on the document with the edited bibliographic information. When the user wishes to discard part of or all of the documents in the document storage box 120, the user may select one of the document photograph thumbnails 522 of the document information screen 520 and click the “delete” button 530 to delete information on the document stored in the document management apparatus 100. For example, when the user clicks the “delete” button 530, the user terminal 110 transmits a “delete” request for the document to the document management apparatus 100 together with unique information stored in the wireless tag 130 of the document storage box 120 from which the document is discarded, and the document management apparatus 100 deletes document information such as document photograph, which has been requested for deletion.

When a user wishes to store a document in a new document storage box, the user may register a new document in the document management apparatus 100 by clicking the “+” button 516 located at the bottom of the document list screen 510. An example of a user interface for this is illustrated in FIG. 6.

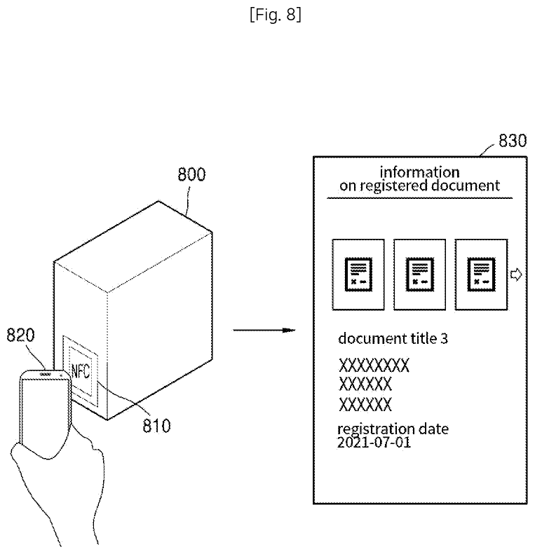

In another embodiment, the document management apparatus 100 may provide license to the document content differently depending on whether the logged-in user account is a licensed account. For example, when the user account used to log in is a licensed account, the document management apparatus 100 may provide user interface 520 including a menu for editing 528 or deleting 530 document content as in the present embodiment. However, when the user account is not a licensed account, the document management apparatus may provide a screen 830 such as the screen in FIG. 8 which does not include a menu for editing or deleting document content, instead of the screen 520 in FIG. 5.

FIGS. 6 and 7 below are drawings illustrating examples of a user interface when logged in with a licensed user account. When the login is from an unlicensed user account, FIGS. 6 and 7 may provide a user interface only for retrieving, rather than a user interface for registering, editing, deleting, etc. document content.

Referring to FIG. 6, when a user clicks the “+” button 516 on the document list screen 510 in FIG. 5, a screen receiving bibliographic information of the document to be registered is displayed on the user terminal 110. The bibliographic information may include various information such as title 602 of document, summary 604, keyword 606, etc., depending on the embodiment. In another embodiment, the user terminal 110 may receive the bibliographic information as a voice input for the visually impaired.

When the user clicks the “next step” button 608 after entering bibliographic information, the user terminal 110 provides a user interface 610 for registering or taking photographs of the document content such as document photograph. When a photograph of the document is previously taken and stored on the user terminal 110, the user may click the “photo album” button 612 and select the document photograph to be registered among the document photographs stored in the user terminal 110. Upon clicking the “take photo” button 614, the user terminal 110 provides a user interface 620 for taking a photograph.

Referring to FIG. 7, the user terminal 110 displays a list of document photographs selected or taken through the process of FIG. 6 on the screen 700. When the user selects a photograph to be registered in the document management apparatus from the document photograph list and clicks the “register” button 702, the user terminal 110 transmits the document content such as document photograph and bibliographic information to the document management apparatus 100, and receives unique information from the document management apparatus 100. The user terminal 110 displays the document information registered in the document management apparatus on the document information screen 710. When the user clicks the “NFC input” button 712 on the document information screen 710, the user terminal 110 provides a user interface 720 for entering the unique information received from the document management apparatus 100 into the wireless tag 130. The user may enter the unique information into the wireless tag 130 by tagging the user terminal 110 with the wireless tag 130.

FIG. 8 is a drawing illustrating an example of a method of checking document information using a wireless tag of the document storage box according to an embodiment of the present invention.

Referring to FIG. 8, a user tags a user terminal 820 with a wireless tag 810 when the user wishes to check information on the document to be stored in the document storage box 800. The user terminal 820 receives unique information from the wireless tag 810, transmits the unique information to the document management apparatus 100, and receives the document information stored being mapped to the unique information from the document management apparatus 100 and displays the same on the screen 830.

For example, when the document management apparatus 100 receives unique information from the user terminal 820, the document management apparatus 100 provides a list of one or more documents mapped to unique information and stored to the user terminal 110 as illustrated in FIG. 2. When a specific document is selected from the list of documents, the document management apparatus 100 transmits document content such as document photograph of the selected specific document, and bibliographic information to the user terminal 820. In other words, the user can check the document photograph or document bibliographic information stored in the document storage box through the tagging of the wireless tag 810 of the document storage box 800. The user may check the content of the document through the document photograph without having to directly take out the document stored in the document storage box 1800.

In another embodiment, the user terminal 820 may manage deletion or addition of documents stored in the document storage box 800 through tagging of the wireless tag 810. For example, upon tagging the wireless tag 810 with the user terminal 820, the user terminal 820 may display a screen including an “edit” or “delete” button like the document information screen in FIG. 6, together with information on the document stored in the document storage box 800. When the user clicks the “edit” button, the user terminal 110 may provide a screen that allows the user to edit bibliographic information of the document so that the bibliographic information can be edited. The user terminal 820 transmits the edited bibliographic information to the document management apparatus 100, and the document management apparatus 100 stores the edited bibliographic information. When the user removes a document from the document storage box 800, the user may click the “delete” button to delete information on the corresponding document stored in the document management apparatus 100. For example, when the user clicks the “delete” button, the user terminal 820 transmits a “delete” request for the corresponding document to the document management apparatus 100 together with unique information of the wireless tag 810, and the document management apparatus 100 deletes the document photograph, which has been requested for deletion.

In another embodiment, information on the document may be provided as a voice input for) the visually impaired. When the user terminal 820 receives information on the document corresponding to the unique information of wireless tag 810 from the document management apparatus 100, the user terminal 820 may output information on the document (e.g., bibliographic information or information included in document content) as an audio message. For example, when an audio recording of information on the document (e.g., bibliographic information) is registered in the document management apparatus 100 together with the document photograph, the user terminal 820 may play the audio recording file received from the document management apparatus 100 to provide information on the document as an audio recording. In another embodiment, the user terminal 820 may include a text-to-speech algorithm and may convert the text of the information on the document to speech and provide the same.

FIGS. 9 to 13 are drawings illustrating examples of a document storage box according to an embodiment of the present invention. FIGS. 9 to 13 illustrate only one embodiment of the document storage box, and the invention is not necessarily limited to the example of FIGS. 9 to 13.

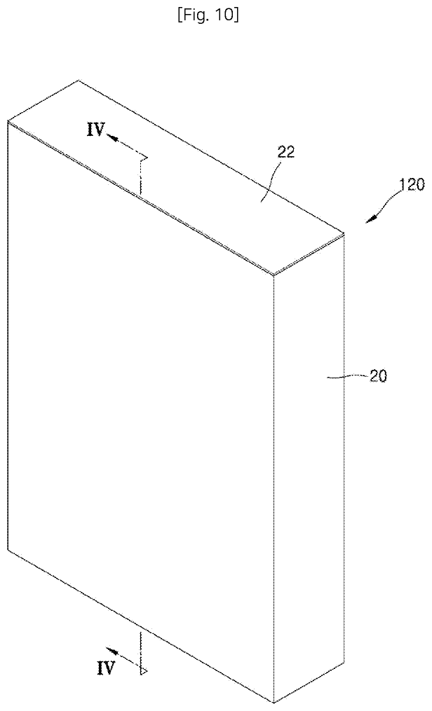

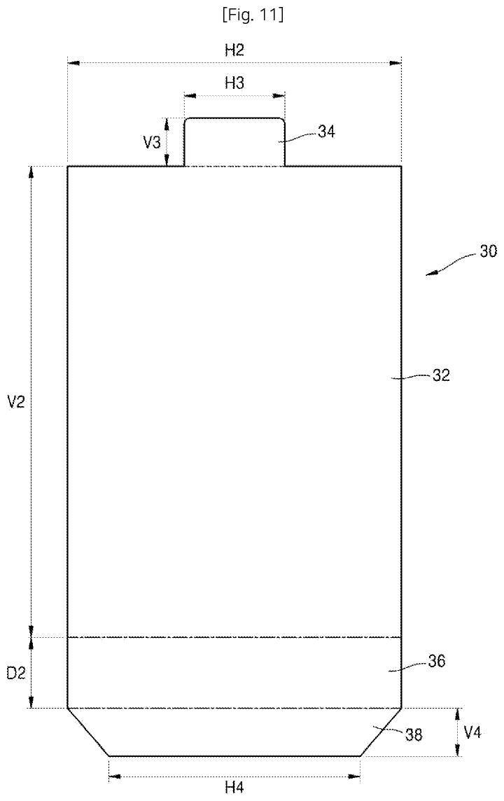

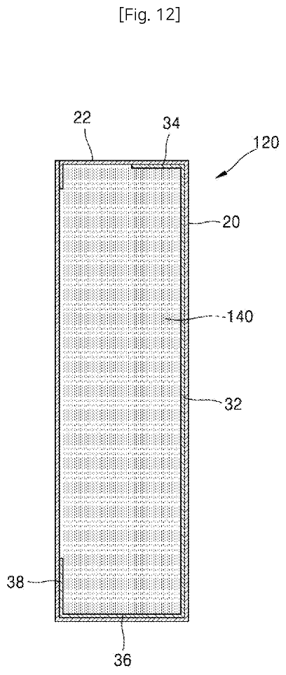

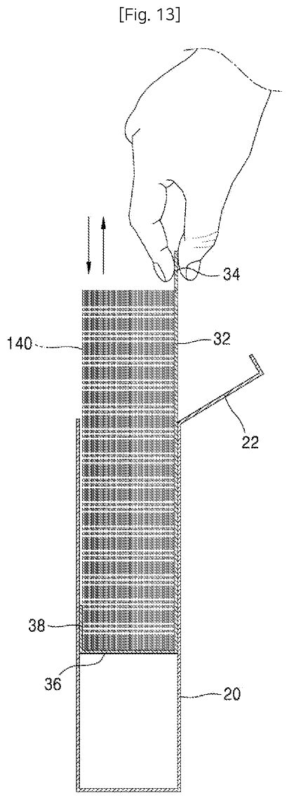

FIG. 9 is an exploded perspective view of a document storage box according to an embodiment of the present invention. FIG. 10 is a drawing illustrating a state in which the tray and storage box illustrated in FIG. 9 are coupled. FIG. 11 is a development view of the tray illustrated in FIG. 9. FIG. 12 is a cross-sectional view taken along line IV-IV illustrated in FIG. 10. FIG. 13 is a drawing illustrating the state of loading or unloading documents into and out of the storage box illustrated in FIG. 9.

Referring to FIGS. 9 to 13, a document storage box 120 (hereinafter, “tray storage”) for easy storing and viewing of the documents according to the present invention comprises a storage box 20 and a tray 30.

The storage box 20 is a box-shaped structure with a cuboidal-shaped interior space provided with a closure 22 at the top. The storage box 20 may be made of, for example, paper, fiber, wood, rubber, synthetic resin, etc. For example, the storage box may be manufactured by cutting and folding a plate-shaped paper. The closure 22 may be integrally formed with the storage box 20. The lower part of the storage box 20 may be provided with an opening structure like the upper part, or may be formed in a closed structure.

The tray 30 is a member slidably received in the interior space of the storage box 20. For example, the tray 30 may be formed by cutting and bending a sheet metal. The tray 30 may be made of, for example, paper, fiber, wood, rubber, synthetic resin, etc. When the tray 30 is made of paper, preferably, the paper used has an average weight of 200 g/m² and 300 g/m² by weight. When the weight of the paper is less than an average weight of 100 g/m² by weight, there is a problem that the strength is not sufficient. Preferably, the thickness of the sheet material configuring the tray 30 is thicker than the thickness of the sheet material configuring the storage box 20. Preferably, the size of the tray 30 is configured to be similar to the size of the interior space of the storage box 20. Preferably, the tray 30 is manufactured to be tightly accommodated in the storage box 20. When the tray 30 is too large, it cannot be accommodated in the interior space of the storage box 20, and when the tray 30 is too small, there is a problem that a gap may be formed between the tray 30 and the storage box 20, which prevents the tray 30 from being fixed to the storage box 20.

When the tray 30 is made of rubber or synthetic resin, it may be manufactured in a mold by injection molding. In an embodiment illustrated in the drawings, the tray 30 is manufactured by folding paper.

The tray 30 comprises a tray body 32, a tip 34, a bottom part 36, and a separation stopper 38.

The tray body 32 is a rectangular plate-shaped structure. The tray body 32 is slidably assembled in the storage box 20 arranged parallel to the inner wall of the storage box 20. Preferably, the longitudinal length V2 of the tray body is configured to be equal to or slightly smaller than the longitudinal length V1 of the interior space. Preferably, the transverse length H2 of the tray body is configured to be approximately equal to the transverse length H1 of the interior space of the storage box. More specifically, the transverse length H2 of the tray body is preferably 90% to 98% of the transverse length H1 of the interior space of the storage box. A decorative through pattern may be formed on the tray body 32 by die cutting. Die cutting is also known in the printing industry as so-called a “dotting” process. Meanwhile, at least one of a decorative photograph, pattern, color, and designed diagram may be printed on the tray body 32. In addition, the tray body 32 may be provided with decorative patterns on one or both sides. Meanwhile, the photographs, patterns, colors provided on the tray body 32 may be attached to the surface of the tray body 32 by means such as an adhesive or double-sided tape. On the other hand, other types of loads other than documents may be attached to the tray body 32 by means such as an adhesive or double-sided tape. In this case, the other type of load may be, for example, packages for medication such as Tylenol or tea bags for green tea.

The tip 34 is disposed at a center part of a top rim of the tray body 32. The tip 34 extends integrally from the tray body 32. The tip 34 serves as a handle for applying an external force to the tray 30 when removing a document 140 accommodated in an interior space of the storage box 20. The tip 34 may be folded with respect to the tray body 32 by an external force. More specifically, the tip 34 is foldably formed about the tray body 32 relative to a top rim of the tray body 32. Preferably, the border line between the tray body 32 and the tip 34 has fold guides by press line processing. By means of the press line processing, the tip 34 is naturally folded inward when the closure 22 of the storage box 20 is closed. When removing the document 140, the tip 34 serves as a handle that may be grasped by a finger to apply an external force. Preferably, the longitudinal length V3 of the tip does not exceed the thickness of the interior space D1 of the storage box. More specifically, the longitudinal length V3 of the tip is preferably between 30% and 95% of the thickness of the interior space D1. Preferably, the transverse length H3 of the tip is smaller than the transverse length H2 of the tray body. More specifically, the transverse length H3 of the tip is preferably between 3% and 25% of the transverse length H2 of the tray body. When the transverse length H3 of the tip is less than 3% of the transverse length H2 of the tray body, there is a problem that the tip 34 cannot be appropriately grasped. When the transverse length H3 of the tip exceeds 25% of the transverse length H2 of the tray body, there is a problem that a large amount of paper is wasted, which is not economical.

The tip 34 is illustrated in the drawings as being rectangular in shape, but the tip 34 may be configured in various shapes such as a square, semicircle, triangle, logo shape, cloud shape, etc. Meanwhile, the tip 34 may be colored in any color of nature such as red, orange, yellow, green, blue, etc. The tip 34 may be labeled or marked with classification information of the stored document 140.

The bottom part 36 is a cantilevered plate-like structure extending perpendicular to the tray body 32 relative to a bottom rim of the tray body 32. In other words, the bottom part 36 extends from the bottom of the tray body 32 parallel to the bottom surface of the storage box 20. The border line between the bottom part 36 and the tray body 32 may configure fold guides by pressed line processing. Preferably, the thickness D2 of the bottom part is formed to be approximately equal to the thickness D1 of the interior space of the storage box. More specifically, the thickness D2 of the bottom part is preferably 90% to 98% of the thickness D1 of the interior space of the storage box. When the thickness D2 of the bottom part is less than 90% of the thickness D1 of the interior space of the storage box, there is a problem that the interior space of the storage box 30 has an excessive amount of empty space in which the document 140 cannot be stored, which is not efficient, and when removing the document 140, the document 140 may fall out of the tray 30 and be missing in the storage box 20. When the thickness D2 of the bottom part exceeds 98% of the thickness D1 of the interior space of the storage box, there is a problem that the storage and separation of the tray 30 is not smooth.

The separation stopper 38 is a structure extending from the bottom part 36. The separation stopper 38 is a cantilevered structure folded upwardly from an end part of the bottom part 36 and parallel to the tray body 32. The separation stopper 38 serves to prevent the document 140 supported on the bottom part 36 from falling out in the direction of the thickness D2 of the bottom part. The separation stopper 38 prevents the documents 140 received in the tray 30 from falling to a lower side of the bottom part 36, and wraps around the lower part of the documents 140 stored in the storage box 20. Accordingly, the separation stopper 38 allows the documents 140 to be pulled up intact along the tray 30 as the tray 30 is held up when the documents 140 are removed from the storage box 20. The border line of the separation stopper 38 and the bottom part 36 may comprise fold guides by pressed line processing. The transverse length H4 of the separation stopper may be configured to be equal to the transverse length H2 of the tray body. Both ends of the separation stopper 38 may be diagonally cut or rounded. Preferably, the longitudinal length V4 of the separation stopper is between 3% and 50% of the longitudinal length V2 of the tray body. When the longitudinal length V4 of the separation stopper is less than 3% of the longitudinal length V2 of the tray body, there is a problem that the document 140 may easily be fallen out from the bottom part 36. When the longitudinal length V4 of the separation stopper exceeds 50% of the longitudinal length V2 of the tray body, there is a problem that a large amount of paper is wasted, which is not efficient. As the thickness D1 of the interior space of the storage box 20 gets thicker, preferably the longitudinal length V4 of the separation stopper is configured to be close to 50% of the longitudinal length V2 of the tray body.

When the tray 30 is made of ordinary paper rather than a special paper, preferably, at least one of the surface of the tray 30 and the other side is treated with a matte or glassy laminating coating. When the tray 30 is coated, it has an effect of increasing its strength and at the same time preventing the occurrence of moisture. In particular, when the inside of the storage box 20 is printed with colors, images, etc., it has an effect of preventing the tray 30 from being stained with ink.

Hereinafter, the effect of the tray storage 120, comprising components as described above, will be described in detail using the process of storing a document 140 in a document box 20 by storing the document 140 in a tray 30, and removing the stored document 140 for viewing as examples.

First, the documents 140 are placed on the tray 30 for storage. A method for placing documents 140 on the tray 30 includes stacking the documents 140 for storage by sliding them onto the tray 30 with the tray body 32 parallel to the ground. When the documents 140 are stacked as much as the length of the bottom part 36, the tray 30 is erected and slidably coupled to the storage box 20, and the closure 22 provided on the storage box 20 is closed. As the closure 22 is closed, the tip 34 is folded under the force of being pressed by the closure 22 to be parallel to the closure 22, as illustrated in FIG. 12. This process allows for easy storage of the document 140. In this process, the document 140 does not require a separate binding process, and thus provides an effect of not damaging the document 140. In addition, since the document does not require a separate binding process, the process provides an effect of saving the operators time and effort.

The process of removing the document 140 from the tray storage 120 to view the stored document 140 will now be described. The closed closure 22 is opened. With the closure 22 open, an operator grasps the tip 34 with his/her hand and pulls the tray 30 upward as illustrated in FIG. 13. Accordingly, the tray 30 containing the document 140 is separated from the storage box 20. With the separated tray 30 lying parallel to the ground or perpendicular to the ground, the required documents 140 may be separated from the tray 30 for easy viewing.

As such, the tray storage for easy storing and viewing of documents according to the present invention prevents damage to the documents stored by the tray slidably received in the storage box, and provides an effect of allowing rapid storage of documents and easy viewing of the stored documents. In addition, the tray configuring the present invention has a structure of being manufactured by folding an unfolded plate, and thus has a low manufacturing cost. Furthermore, the storage box according to the present invention has an effect of minimizing environmental pollution because it does not use non-environmental parts such as plastic, metal used for conventional document binding, and may be made of a single material. In addition, the tray storage for easy storing and viewing of documents according to the present invention has the advantage of being useful not only for documents but also for various packaging industries.

FIG. 14 is a drawing illustrating an example of an overall system structure for licensed document management according to an embodiment of the present invention.

Referring to FIG. 14, the document management apparatus 100 may grant at least one license to at least one group 1400, 1410, 1420. A license means a right allowing the document management apparatus 100 to retrieve, register, edit, or delete document content. For example, the document management apparatus 100 may provide at least one license key to each of the groups 1400, 1410, 1420. The document management apparatus 100 may store and manage information on user accounts that have been granted license keys to each of the groups 1400, 1410, 1420.

Users of each group 1400, 1410, 1420 may access the document management apparatus 100 via a user terminal through a login process using a user account and retrieve, register, edit, or delete document content. At this time, the scope of the user's rights to the document content varies depending on whether the user's user account 1430 is licensed. For example, the first user account 1430 of the first group 1400 may be licensed and the second user account may not be licensed. In this case, a user accessing with the first user account 1430 has full access to retrieve, register, edit, or delete document content. However, since the user accessing with the second user account is not licensed, the second user account only has limited access to the document content (e.g., retrieving, etc.).

The present embodiment illustrates a plurality of groups 1400, 1410, 1420, but there may be only one group, depending on the embodiment. Each group 1400, 1410, 1420 may be a company or a division within a company. For example, the first group 1400 may be company A, the second group 1410 may be company B, the Nth group 1420 may be company C, which are three different companies. Alternatively, the first group to Nth group 1400, 1410, 1420 may be different departments within the same company. In addition, each group 1400, 1410, 1420 may be in various forms according to embodiments, and are not limited to any one form.

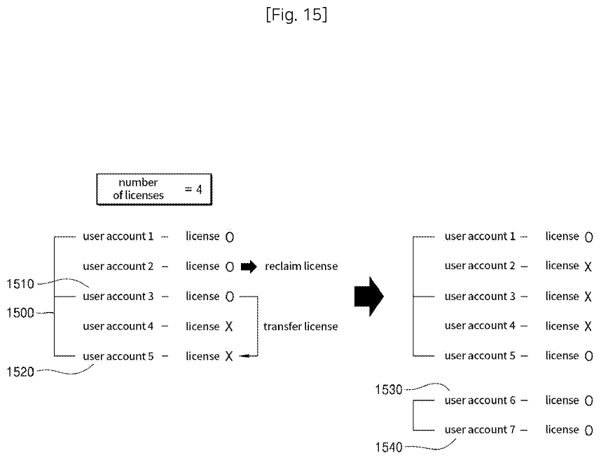

Each group 1400, 1410,1420 comprises at least one user account 1430 that uses at least one license granted by the document management apparatus 100. There may be an administrator account for each group 1400, 1410, 1420, or there may be one administrator account that manages the entire group 1400, 1410, 1420. The administrator may access the document management apparatus 100 with the administrator account to grant, reclaim, or transfer licenses granted to the group 1400, 1410,1420 to user accounts within the group. Granting, reclaiming, and transferring licenses will be discussed again in FIG. 15.

The document content managed by the document management apparatus 100 may include various contents related to the documents, such as electronic documents, document photographs, etc. For example, the document content may be data obtained by scanning or taking a photograph of a physical document. In another embodiment, the document management apparatus 100 may store and manage document content by mapping physical documents to document content. A method of storing a physical document in a document storage box and registering document content, including a photograph of the document stored in the document storage box, in the document management apparatus is illustrated in FIGS. 1 to 8.

FIG. 15 is a drawing illustrating an example of a licensed management method according to an embodiment of the present invention. For the sake of convenience in explanation, it is assumed that four licenses are granted to the group 1500.

Referring to FIG. 15, an administrator may grant licenses to a first user account, a second user account, and a third user account. The administrator may also reclaim, transfer, or add licenses.

In an embodiment, the administrator may reclaim and remove the license granted to a second user account. For example, the document management apparatus 100 removes the license granted to the second user account when the administrator accessing the administrator account requests to reclaim the license of the second user account. The second user account from which the licensed is removed has limited access to the document management apparatus 100, such as retrieving. In addition, the scope of access to the document management apparatus 100 may be variously defined depending on the embodiment.

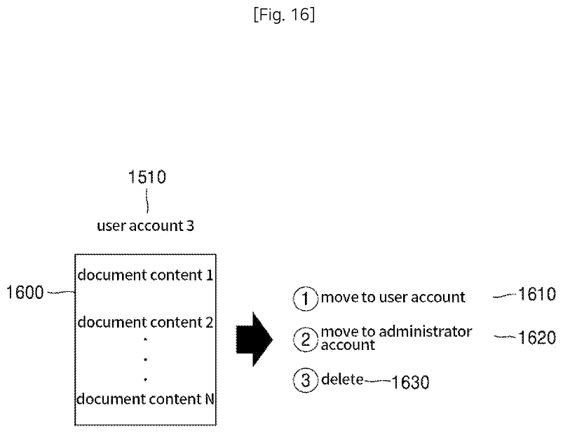

In another embodiment, the administrator may transfer the license granted to a third user account 1510 to a fifth user account 1520. For example, the document management apparatus 100 transfers the license of the third user account 1510 to the fifth user account 1520 when an administrator accessing the administrator account requests to transfer the license of the third user account 1510 to the fifth user account 1520. When the license is transferred, the management entity of the document content registered by the third user account 1510 may be transferred to the fifth user account 1520 or the administrator account, or the document content may be deleted. This will be discussed again in FIG. 16.

In another embodiment, the administrator may grant licenses to a sixth user account 1530 and a seventh user account 1540, respectively. In other words, the document management apparatus 100 may grant new licenses to the sixth and seventh user accounts 1530,1540, respectively, at the request of the administrator. There are four licenses in the group, and since the license was previously reclaimed from the second user account, there are two unassigned licenses for the user accounts in the group. Thus, the administrator may grant new licenses to the user account within the total number of licenses granted to the group.

The user accounts that are ultimately assigned licenses by reclaiming, transferring, adding, etc. licenses in the present embodiment are the first user account, the fifth user account, the sixth user account and the seventh user account. The administrator may further reclaim, transfer, or add licenses granted to the user accounts within the total number of licenses in the group.

FIG. 16 is a drawing illustrating an example of a method of moving document content according to an embodiment of the present invention.

Referring to FIGS. 15 and 16 together, the license of the third user account 1510 has been transferred to the fifth user account 1520. As a result of the license transfer, the third user account 1510 can no longer register, edit, delete document content, etc.

Upon transferring the license of the third user account 1510 to the fifth user account 1520, the document management apparatus 100 may move the document content 1600 previously registered by the third user account 1510 to another user account or administrator account 1610, 1620, or delete the document content 1600 (1630).

In an embodiment, the document management apparatus 100 may provide, to the user terminal, a user interface that allows the user to select to move or delete the document content 1600 registered by the third user account 1510. For example, when the document management apparatus 100 receives information on a user account to which the document content 1600 is to be moved (e.g., a fifth user account 1520 or administrator account or another third user account from which the license was transferred) from an administrator via the user interface, the document content 1600 of the third user account 1510 is moved to the user account input by the administrator. Alternatively, upon receiving a request to delete the document content 1600 from the administrator via the user interface, the document management apparatus 100 may delete the document content 1600 of the third user account 1510.

In another embodiment, the document management apparatus 100 may display a fifth user account 1520 from which the license of the third user account 1510 has been transferred in a user interface to allow an administrator to easily select the fifth user account 1520 to which the document content 1600 is to be transferred.

In another embodiment, the document management apparatus 100 may display a list of the document content 1600 registered by a third user account 1510 in a user interface, receive a selection from the administrator of part of the list of the document content 1600, and receive an input from the administrator of a user account (e.g., a fifth user account or an administrator account, etc.) to which the selected document content 1600 is to be transferred. In other words, the document content 1600 of the third user account 1510 may be divided and each may be transferred to a different user account. Alternatively, the document management apparatus 100 may delete some of the document content 1600 registered by the third user account 1510 at the request of the administrator and transfer the remainder to at least one user account.

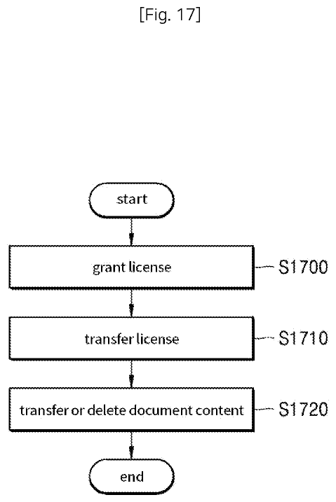

FIG. 17 is a flow chart illustrating an example of a licensed document management method according to an embodiment of the present invention.

Referring to FIG. 17, the document management apparatus 100 grants a license to at least one user account to edit, delete, or register document content (S1700). For example, the document management apparatus 100 may grant a license to at least one user account within a number of licenses at the request of an administrator.

The document management apparatus 100 may transfer the license of a first user account to a second user account (S1710). Alternatively, the document management apparatus 100 may reclaim a license, as illustrated in FIG. 15, at the request of the administrator. When the license is transferred, the document management apparatus 100 may transfer the document content registered by the first user account to the second user account or administrator account to which the license is transferred, or may delete the document content (S1720). In an embodiment, the object to which the document content is transferred when the license is transferred may be predetermined. An example of moving document content upon license transfer is illustrated in FIG. 16.

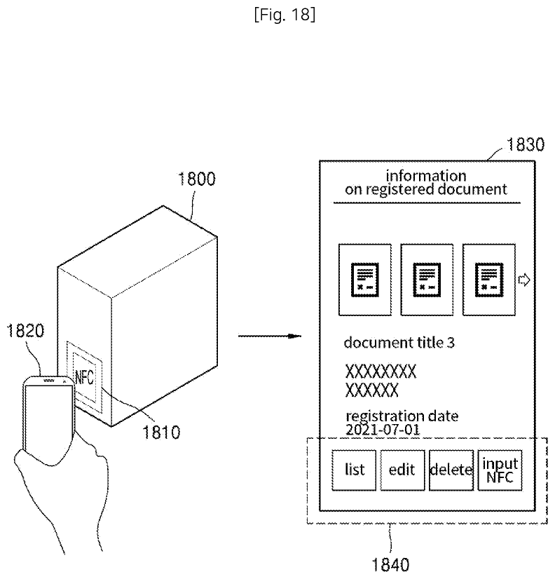

FIG. 18 is a drawing illustrating an example of a method of checking document information when logging in with a licensed user account.

Referring to FIG. 18, when logged in with a licensed user account, the user terminal 1820 may manage the retrieval of the document stored in the document storage box 1800, as well as deletion or addition of documents through tagging of the wireless tag 1810. For example, upon tagging the wireless tag 1810 with the user terminal 1820, the user terminal 1820 may display a screen 1830 that includes a menu 1840 such as “edit” or “delete,” together with information on the document stored in the document storage box. When the user clicks the “edit” button, the user terminal 1820 may provide a screen for editing the bibliographic information of the document to allow editing of the bibliographic information. The user terminal 1820 transmits the edited bibliographic information to the document management apparatus 100 and the document management apparatus 100 stores the edited bibliographic information. When a user removes a document from the document storage box 1800, the user may click the “delete” button to delete information on the corresponding document stored in the document management apparatus 100. For example, when a user clicks the “delete” button, the user terminal 1820 transmits a “delete” request of the document together with unique information of the wireless tag 1810 to the document management apparatus 100, and the document management apparatus 100 deletes the document content requested for deletion. In another embodiment, when logged in with an unlicensed user account, the document management apparatus 100 may provide a user interface (e.g., screen 830 in FIG. 8) excluding the menus 1840 for editing or deleting document content.

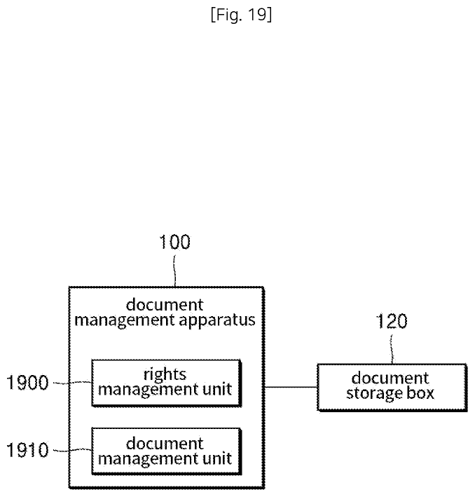

FIG. 19 is a drawing illustrating the configuration of an example of a document management apparatus according to an embodiment of the present invention.

Referring to FIG. 19, the document management apparatus 100 comprises a rights management unit 1900 and a document management unit 1910. In an embodiment, the document management apparatus 100 may be implemented as a computing device comprising a memory, a processor, and input/output devices, in which case each configuration may be implemented as software, loaded into the memory, and then performed by the processor.

The rights management unit 1900 manages the licenses. The rights management unit 1900 grants at least one license to a group to each of the groups illustrated in FIG. 14. For the sake of convenience in explanation, it is assumed that only one group exists. The rights management unit 1900 may grant a license key to at least one user account by a method of granting license. For example, the rights management unit 1900 may manage which user account is licensed by mapping and storing information of license keys and user accounts.

The rights management unit 1900 may grant a new license to a user account, transfer a license held by a first user account to a second user account, or reclaim a license held by a first user account. For example, the rights management unit 1900 may provide a user interface that allows an administrator logged into an administrator account to grant, reclaim, or transfer licenses for a plurality of user accounts. An example of how an administrator may grant, reclaim, transfer, etc. licenses is illustrated in FIG. 15.

When a license is transferred from a first user account to a second user account, the document management unit 1910 transfers and/or deletes the document content of the first user account to a new user account or an administrator account. For example, the document management unit 1910 may provide a user interface that allows an administrator to transfer or delete document content based on the license transfer. An example of how document content may be processed following a license transfer is illustrated in FIG. 16.

The document management unit 1910 may also register, edit or delete the document content illustrated in FIGS. 1 to 8. For example, the document management unit 1910 may receive and store document content including a document photograph obtained by taking a photograph of a document stored in the document storage box 120. Only a user account licensed by the rights management unit 1900 is allowed to register, edit or delete the document content. An unlicensed user account is allowed only to retrieve document content. Examples of user interfaces provided depending on whether a user account is licensed are illustrated in FIGS. 8 and 18, respectively.

The present invention may also be implemented as a computer-readable code on a computer-readable recording medium. A computer-readable recording medium includes any type of recording device that stores data that can be read by a computer system. Examples of computer-readable recording medium includes ROM, RAM, CD-ROM, SSD, and optical data storage. In addition, computer-readable recording medium can also be distributed across networked computer systems to store and execute computer-readable code in a distributed manner.

The present invention has been described above with reference to its preferred embodiments. A person skilled in the art will understand that the invention may be implemented in modified forms without departing from the essential features of the present invention. Thus, the disclosed embodiments are to be considered from an illustrative point of view and not a limiting point of view. The scope of the present invention is shown in the claims, not in the foregoing description, and all differences within an equivalent scope of the claims are to be construed as being included in the invention.

What is claimed is:

1. A document management method performed by a user terminal, comprising:
obtaining document content on a document to be stored in a document storage box;
registering the document content in a document management apparatus;
receiving unique information from the document management apparatus; and
inputting the unique information into a wireless tag located at one side of the document storage box in which the document is stored.

2. The document management method of claim 1, wherein the wireless tag is NFC tag.

3. The document management method of claim 1, comprising:
logging in to the document management apparatus;
receiving a document list registered in the document management apparatus and displaying the same; and
when one document is selected from the document list, displaying document content on the selected document.

4. The document management method of claim 1, further comprising:
when logging in with a user account licensed by the document management apparatus, receiving user interface including a menu for editing or registering document content; and
when logging in with an unlicensed user account, receiving user interface excluding the menu so that editing or registration of document content is not possible.

5. The document management method of claim 1, wherein the step of obtaining the document content comprises:
receiving bibliographic information comprising title of document and keywords; and
obtaining a photograph of the document by taking a photograph of at least one document mapped to the bibliographic information.

6. The document management method of claim 1, further comprising:
tagging a wireless tag attached to the document storage box; and
receiving, from the document management apparatus, document content on the document stored in the document storage box based on the unique information stored in the wireless tag.

7. The document management method of claim 6, further comprising: outputting information on the document received from the document management apparatus by voice.

8. The document management method of claim 1, further comprising:
obtaining new document content on a new document to be stored in the document storage box; and
transmitting the new document content, together with the unique information obtained by tagging the wireless tag, to the document management apparatus for registration,
wherein the new document content is mapped to the unique information and stored in the document management apparatus.

9. A document management method performed by a document management apparatus, comprising:
receiving document content on a document stored in a document storage box; and
mapping the document content to unique information assigned to a wireless tag located at one side of the document storage box, and storing the same.

10. The document management method of claim 9, further comprising:
granting at least one user account a license to edit, delete, or register document content; and
transferring a first user account's license to a second user account.

11. The document management method of claim 9, further comprising:
transferring document content registered by the first user account to the second user account or administrator account, or deleting the same.

12. The document management method of claim 9, further comprising:
upon receiving a retrieval request comprising unique information of a wireless tag located at one side of the document storage box, searching the database for document content stored by mapping the unique information and providing the same.

13. The document management method of claim 12, comprising:
when the retrieval request is a request from a licensed user account, providing a user interface including a menu for editing or registering the document content; and
when the retrieval request is not a request from a licensed user account, providing a user interface excluding the menu so that editing or registration of document content is not possible.

14. A document management system, comprising: at least one document storage box for storing documents; and a wireless tag attached at one side of each document storage box, wherein the wireless tag comprises unique information identifying the document content on the document stored in the document storage box.

15. The document management system of claim 14, wherein the wireless tag receives unique information from the user terminal that takes a photograph of the document stored in the document storage box, and stores the same.

16. The document management system of claim 14, wherein the document storage box comprises a storage box having a cuboidal shaped interior space provided with a closure at the top; and a tray slidably received in the interior space of the storage box, and the tray comprises: a plate-shaped tray body slidably assembled in a position parallel to the inner wall of the storage box; a tip disposed at a center part of a top rim of the tray body, extending integrally from the tray body and foldably formed about the tray body relative to a top rim of the tray body; a cantilevered bottom part extending perpendicular to the tray body relative to a bottom rim of the tray body; and a cantilevered separation stopper folded upwardly from the bottom part and parallel to the tray body.

17. A computer-readable recording medium recording a computer program for performing the method recited in claim 1 by a computer.

18. A computer-readable recording medium recording a computer program for performing the method recited in claim 9 by a computer.
